(19) United States
(12) Patent Application Publication
(10) Pub. No.: US 2006/0068966 A1
(43) Pub. Date: Mar. 30, 2006

(54) Multi-speed planetary transmission

(76) Inventor: Donald Klemen, Carmel, IN (US)

Correspondence Address: LESLIE C. HODGES;General Motors Corporation, Mail Code 482-C23-B21, P.O. Box 300, Detroit, MI, 48265-3000, US

(21) Appl. No.: 10/951,380

(22) Filed: Sep. 28, 2004

(51) Int. Cl. F16H 3/62

(52) U.S. Cl. 475/275

(57) ABSTRACT

A multi-speed planetary transmission incorporates three planetary gearsets and six torque-transmitting mechanisms to provide six forward speed ratios and two reverse speed ratios. The torque-transmitting mechanisms include three rotating type torque-transmitting mechanisms and three stationary type torque-transmitting mechanisms. The planetary gearsets are interconnected with each other and the other planetary gearsets have a member continuously connected with the output shaft. Connection between the transmission input shaft and the planetary gearset is only by way of rotating type torque-transmitting mechanisms.

### TECHNICAL FIELD

This invention relates to multi-speed planetary transmissions and, more particularly, to planetary transmissions having three planetary gearsets and providing six forward speed ratios and at least one reverse speed ratio.

### BACKGROUND OF THE INVENTION

The automotive and light truck transmissions have evolved a multi-speed countershaft transmission as well as a two and three-speed planetary transmission into multiple speed planetary transmissions wherein five or more speed ratios are provided through the planetary gearsets between the input shaft and the output shaft of the transmission. In many of these transmissions, six forward speed ratios and one reverse speed ratio are provided. The transmissions providing six forward speed ratios use between five and seven friction devices or torque-transmitting mechanisms, generally termed clutches and brakes or reaction clutches.

Two such transmissions are described in U.S. Pat. No. 4,070,927 issued to Polak on Jan. 31, 1978, and U.S. Pat. No. 5,106,352 issued to Lepelletier on Apr. 21, 1992. Other transmissions that demonstrate the ability to provide at least six forward speeds are described in U.S. Pat. No. 6,071,208 issued to Koivunen on Jun. 6, 2000, U.S. Pat. No. 5,755,636 issued to Justice et al. on May 26, 1998, and U.S. Pat. No. 6,083,135 issued to Baldwin et al. on Jul. 4, 2000. Each of the aforementioned patents contain three planetary gearsets and between five and seven torque-transmitting mechanisms.

### SUMMARY OF THE INVENTION

It is an object of the present invention to provide an improved multi-speed transmission having three planetary gearsets and a plurality of torque-transmitting mechanisms.

In one aspect of the present invention, the planetary gearsets are interconnected such that a first of the planetary gearsets is interconnected with both a second a third of the planetary gearsets and members of the second and third planetary gearsets are also interconnected as are members of the first and third of the planetary gearsets.

In yet another aspect of the present invention, the planetary gearset has one member of the second of the planetary gearsets continuously connected with a final or output drive of the transmission.

In still another aspect of the present invention, an input shaft is connectible with the planetary gearsets through three rotating type torque-transmitting mechanisms.

In yet still another aspect of the present invention, one of the rotating type torque-transmitting mechanisms is selectively connectible with a member of the first and third planetary gearsets.

In a yet still another aspect of the present invention, one of the torque-transmitting mechanisms is selectively connectible with another member of the first planetary gearset and a third of the torque-transmitting mechanisms is selectively connectible between the input shaft and members of each of the planetary gearsets.

In a further aspect of the present invention, three stationary type torque-transmitting mechanisms are selectively operable to connect members of the planetary gearsets with a stationary transmission member.

In yet a further aspect of the present invention, one of the stationary torque-transmitting mechanisms is selectively connectible with a member connected to the second of the rotating type torque-transmitting mechanisms.

In yet a further aspect of the present invention, a second of the stationary torque-transmitting mechanisms is selectively connectible with three interconnected members of the planetary gearsets.

In a yet still further aspect of the present invention, one of the stationary torque-transmitting mechanisms is connected to interconnected members of the second and third planetary gearsets.

### DESCRIPTION OF THE DRAWINGS

FIG. 1 is a schematic representation of a powertrain including a multi-speed transmission incorporating the present invention.

FIG. 2 is chart describing the ratios available and the shift sequence of the torque-transmitting mechanisms as well as the ring gear/sun gear tooth ratios of the planetary gearsets.

### DESCRIPTION OF AN EXEMPLARY EMBODIMENT

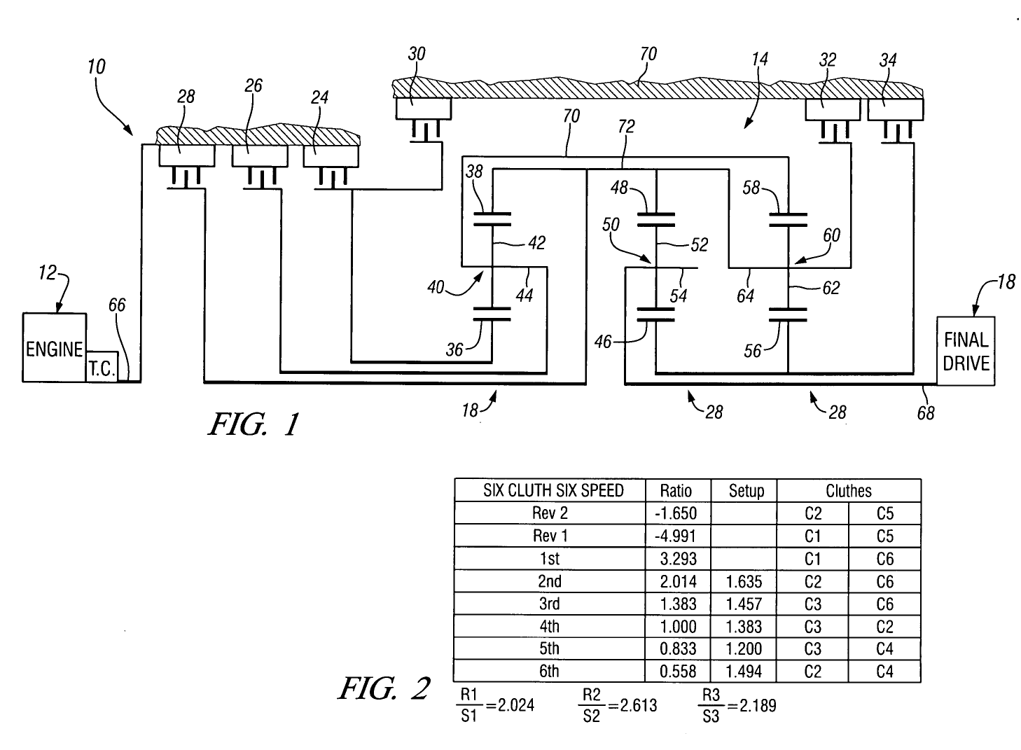

Referring to the drawings, there is seen in FIG. 1 a powertrain generally designated 10 having an engine and torque converter assembly 12, a planetary transmission 14, and a conventional final drive mechanism 16. The engine and torque converter 12 are also conventional mechanisms well known to those skilled in the art of power transmissions. The transmission 14 includes three planetary gearsets 18, 20, and 22, and six torque-transmitting mechanisms 24, 26, 28, 30, 32, and 34.

The planetary gearset 18 includes a sun gear member 36, a ring gear member 38, and a planet carrier assembly member 40, which is comprised of a plurality of pinion gears 42 rotatably mounted on a planet carrier member 44 and disposed in meshing relationship with the sun gear member 36 and the ring gear member 38.

The planetary gearset 20 includes a sun gear member 46, a ring gear member 48, and a planet carrier assembly member 50, which is comprised of a plurality of pinion gears 52 rotatably mounted on a planet carrier member 54 and disposed in meshing relationship with the sun gear member 46 and the ring gear member 48.

The planetary gearset 22 includes a sun gear member 56, a ring gear member 58, and a planet carrier assembly member 60, which is comprised of a plurality pinion gears 62 rotatably mounted on a planet carrier member 64 and disposed in meshing relationship with the sun gear member 56 and the ring gear member 58.

The transmission 14 also includes an input shaft 66 drivingly connected with the engine and torque converter 12 and an output shaft 68 drivingly connected with the final drive mechanism 16.

The sun gear member 36 is operatively connectible with the input shaft 66 through the torque-transmitting mechanism 24. The planet carrier member 44 and ring gear member 58 are interconnected by an interconnecting member 70, and also selectively connectible with the input shaft 66 through the torque-transmitting mechanism 26.

The ring gear member 38 is interconnected with the ring gear member 48 and the planet carrier member 64 through an interconnecting member 72, and is selectively connectible with the input shaft 66 through torque-transmitting mechanism 28 and selectively connectible with a stationary transmission housing 74 through the torque-transmitting mechanism 32. The planet carrier member 54 is continuously connected with the output shaft 68.

The sun gear members 46 and 56 are continuously interconnected by an interconnecting member 76, and selectively connectible with the housing 74 through the torque-transmitting mechanism 34. The sun gear member 36 is selectively connectible with the transmission housing 74 through the torque-transmitting mechanism 30.

In the chart shown in FIG. 2, the reference to C1 is torque-transmitting mechanism 24, the reference to C2 is torque-transmitting mechanism 26, the reference to C3 is torque-transmitting mechanism 28, the reference to C4 is torque-transmitting mechanism 30, the reference to C5 is torque-transmitting mechanism 32, and the reference to C6 is torque-transmitting mechanism 34. For the ring gear/sun gear tooth ratios, R1/S1 is for planetary gearset 18, R2/S2 is for planetary gearset 20, and R3/S3 is for planetary gearset 22.

The chart of FIG. 2 describes the engagement sequence for the torque-transmitting mechanisms so that six forward speed ratios and two reverse speed ratios are established. In reviewing the chart of FIG. 2, those skilled in the art will recognize that three of the forward speed ratios are underdrives, two of the forward speed ratios are overdrives and one of the forward speed ratios is a direct drive. The step ratios between adjacent speed ratios are well within the values acceptable for truck operation. A review of the engagement schedule for the torque-transmitting mechanisms will show that the interchanges of the six forward speed ratios are single transition interchanges, that is, a single friction device is disengaged while another single friction device is on-coming. Also, it will be noted that skip shifts are possible, for example, a first-to-third skip shift is possible, a second-to-fourth skip shift is possible, a third-to-fifth skip ship is possible, and a second-to-fourth-to-sixth skip shift is possible in single transition fashion.

In summary, the planetary transmission 14 includes three planetary gearsets, a member of the first planetary gearset being interconnected with a member of the third planetary gearset, another member of the first planetary gearset being interconnected with a member of the second planetary gearset and another member of the third planetary gearset, the second planetary gearset having a member continuously connected with the transmission output shaft, and the second and third planetary gearsets having an interconnected member. One member of the first planetary gearset, which might be termed an input planetary gearset, is connectible only with the torque-transmitting mechanism between the gear and the input shaft and two interconnected members of the second and third planetary gearsets are connectible only to the transmission housing through a selectively engageable torque-transmitting mechanism.

1. A multi-speed planetary transmission comprising:
an input shaft;
an output shaft;
a stationary housing;
a first planetary gearset having first, second, and third members;
a second planetary gearset having first, second, and third members;
a third planetary gearset having first, second, and third members;
said first member of said first planetary gearset being selectively connectible with said input shaft through a first selectively engageable torque-transmitting mechanism and with said transmission housing through a second selectively engageable torque-transmitting mechanism;
said second member of said first planetary gearset and said first member of said third planetary gearset being continuously interconnected and selectively connectible with said input shaft through a third torque-transmitting mechanism;
said third member of said first planetary gearset, said first member of said second planetary gearset, and said second member of said third planetary gearset being continuously interconnected and selectively connectible with said input shaft through a fourth torque-transmitting mechanism and selectively connectible with said transmission housing through a fifth selectively engageable torque-transmitting mechanism;
said second member of said second planetary gearset being continuously interconnected with said output shaft;
said third member of said second planetary gearset being continuously interconnected with said third member of said third planetary gearset and selectively connectible with said transmission housing through a sixth torque-transmitting mechanism; and
said six torque-transmitting mechanism being selectively engageable in combinations of two to provide six forward speed ratios and at least one reverse speed ratio.

2. The multi-speed planetary transmission defined in claim 1 wherein:
said first, second, and third members of said first planetary gearset are a sun gear, a planet carrier, and a ring gear, respectively;
said first, second, and third members of said second planetary gearset are a ring gear, a planet carrier, and sun gear, respectively;
said first, second, and third members of said third planetary gearset are a ring gear, a planet carrier, and a sun gear, respectively.
